(19) United States
(12) Patent Application Publication
(10) Pub. No.: US 2026/0285710 A1
(43) Pub. Date: Sep. 24, 2026

(54) WATER TREATMENT APPARATUS FOR DECOMPOSING PERFLUORINATED COMPOUND ON BASIS OF VACUUM ULTRAVIOLET RAYS

(71) Applicant: SEOUL NATIONAL UNIVERSITY R&DB FOUNDATION, Seoul (KR)

(72) Inventors: Kyung Duk ZOH, Seoul (KR); Tae Yeon KIM, Seoul (KR)

(73) Assignee: SEOUL NATIONAL UNIVERSITY R&DB FOUNDATION, Seoul (KR)

(21) Appl. No.: 19/167,384

(22) PCT Filed: Mar. 22, 2024
(86) PCT No.: PCT/KR2024/003611

§ 371 Date: Sep. 21, 2025

(30) Foreign Application Priority Data
May 30, 2023 (KR) 10-2023-0069058

(51) Int. Cl. C02F 1/32; C02F 1/58; C02F 1/70; C02F 1/72; C02F 101/36

(52) U.S. Cl. CPC C02F 1/325; C02F 1/58; C02F 1/70; C02F 1/722; C02F 2101/36; C02F 2201/004; C02F 2201/005; C02F 2201/007; C02F 2201/3227; C02F 2209/06; C02F 2209/22

(57) ABSTRACT

A water treatment apparatus for decomposing a perfluorinated compound on the basis of vacuum ultraviolet rays, according to the present invention, connects a plurality of water treatment pipes each having a vacuum ultraviolet irradiation device in series, so as to sequentially perform oxidation, treatment, reduction treatment, and oxidation treatment while water to be treated sequentially passes through the water treatment pipes, thereby being capable of decomposing, among perfluorinated compounds in the water to be treated, fluorotelomers in which carbon (C) and hydrogen (H) are combined as well as perfluoroalkyls in which carbon (C) and fluorine (F) are combined, and bonds between carbon (C) and hydrogen (H) and bonds between carbon (C) and fluorine (F) can both be decomposed in decomposition products additionally generated during oxidation or reduction treatment reactions, and accordingly, through a series of processes, water treatment efficiency can be improved.

### TECHNICAL FIELD

The present invention relates to a water treatment apparatus for decomposing a perfluorinated compound on the basis of vacuum ultraviolet rays, and more particularly, to a water treatment apparatus for decomposing a perfluorinated compound on the basis of vacuum ultraviolet rays in which decomposition and defluorination of the perfluorinated compound can be achieved.

### BACKGROUND ART

In general, water treatment apparatuses are facilities for removing contaminants in water. Perfluorinated compounds, among one of the contaminants in water, are a group of substances in which hydrogen in the basic skeleton of hydrocarbon is replaced by fluorine, and the perfluorinated compounds are chemically very stable, are not easily decomposed, and are accumulated in living organisms, causing toxicity.

Since water treatment apparatuses according to the related art have removed perfluorinated compounds using a physical treatment method such as adsorption, filtering or the like, but there is a limitation, the concern about decomposition through chemical treatment is also increasing. However, even when decomposed through chemical treatment, there is a problem in that decomposition products containing bonds between carbon (C) and fluorine (F) remain ecologically toxic.

### DETAILED DESCRIPTION OF THE INVENTION

### Technical Problem

The present invention provides a water treatment apparatus for decomposing a perfluorinated compound on the basis of vacuum ultraviolet rays in which decomposition and defluorination of the perfluorinated compound can be performed.

### Technical Solution

According to an aspect of the present invention, there is provided a water treatment apparatus for decomposing a perfluorinated compound on the basis of vacuum ultraviolet rays, the water treatment apparatus including: a treatment water inflow pipe into which water to be treated, including perfluoroalkyl substances (PFAS) in which carbon (C) of the alkyl group is saturated with fluorine (F), and fluorotelomer substances in which some of carbon (C) of the alkyl group is not replaced by fluorine (F) and remains as hydrogen (H), flows; a first oxidation treatment pipe, which communicates with the treatment water inflow pipe and is equipped with a first vacuum ultraviolet irradiation device and in which an advanced oxidation treatment reaction in which bonds between carbon (C) and hydrogen (H) in the perfluorinated compound are broken using vacuum ultraviolet rays and the perfluorinated compound is decomposed, is performed; a second reduction treatment pipe, which communicates with the first oxidation treatment pipe and is equipped with a second vacuum ultraviolet irradiation device and in which an advanced reduction treatment reaction in which bonds between carbon (C) and fluorine (F) in the perfluorinated compound that is not decomposed in the first oxidation treatment pipe are broken using vacuum ultraviolet rays and a reducing agent and the perfluorinated compound is decomposed, is performed; and a third oxidation treatment pipe, which communicates with the second reduction treatment pipe and is equipped with a third vacuum ultraviolet irradiation device and in which bonds between carbon (C) and hydrogen (H) in the perfluorinated compound that is not decomposed are broken using vacuum ultraviolet rays and an oxidizer and the perfluorinated compound is decomposed.

In the first oxidation treatment pipe, vacuum ultraviolet rays generated in the first vacuum ultraviolet irradiation device may photolyze water to generate OH radicals, and the OH radicals may break bonds between carbon (C) and hydrogen (H) in the perfluorinated compound so that the perfluorinated compound is decomposed.

The reducing agent may include sulfite, and in the second reduction treatment pipe, vacuum ultraviolet rays generated in the second vacuum ultraviolet irradiation device may photolyze the sulfite to generate hydration electrons, and the hydration electrons may break bonds between carbon (C) and fluorine (F) in the perfluorinated compound that is not decomposed in an advanced oxidation treatment reaction of the first oxidation treatment pipe and bonds between carbon (C) and fluorine (F) in a first decomposition product additionally generated in the advanced oxidation treatment reaction, thereby defluorinating the perfluorinated compound.

The oxidizer may include peroxide hydrogen, and in the third oxidation treatment pipe, vacuum ultraviolet rays generated in the third vacuum ultraviolet irradiation device may decompose peroxide hydrogen to generate OH radicals, and the OH radicals may break bonds between carbon (C) and hydrogen (H) in a second decomposition product in which, in an advanced reduction treatment reaction of the second reduction treatment pipe, fluorine (F) is replaced by hydrogen (H) and which is additionally generated, so that the perfluorinated compound is decomposed.

The water treatment apparatus may further include a first connection pipe that connects between the first oxidation treatment pipe and the second reduction treatment pipe, and a reducing agent injection unit for injecting the reducing agent into the first connection pipe.

A pH regulator for regulating pH of water to be treated, and nitrogen for removing dissolved oxygen in water to be treated, may be injected into the first connection pipe.

The water treatment apparatus may further include a second connection pipe that connects between the second reduction treatment pipe and the third oxidation treatment pipe, and an oxidizer injection unit for injecting the oxidizer into the second connection pipe.

The water treatment apparatus may further include a discharge pipe connected to a discharge port of the third oxidation treatment pipe and configured to discharge water to be treated, from the third oxidation treatment pipe to the outside, and a water quality measuring device provided in the discharge pipe and configured to measure water quality of water to be treated.

The water treatment apparatus may further include a return pipe, which is branched from the discharge pipe and connected to the treatment water inflow pipe and in which, when water quality measured by the water quality measuring device exceeds a preset reference, some of water to be treated discharged through the discharge pipe is returned to the treatment water inflow pipe, and a return pipe valve which opens/closes the return pipe.

The reducing agent may include sulfite, and the oxidizer may include peroxide hydrogen, and the water quality measuring device measures fluorine ions, hydrogen peroxide concentration, and sulfite ion concentration, in water to be treated.

According to another embodiment of the present invention, there is provided a water treatment apparatus for decomposing a perfluorinated compound on the basis of vacuum ultraviolet rays, the water treatment apparatus including: a treatment water inflow pipe into which water to be treated, including perfluoroalkyl substances (PFAS) in which carbon (C) of the alkyl group is saturated with fluorine (F), and fluorotelomer substances in which some of carbon (C) of the alkyl group is not replaced by fluorine (F) and remains as hydrogen (H), flows; a first oxidation treatment pipe, which communicates with the treatment water inflow pipe and is equipped with a first vacuum ultraviolet irradiation device and in which an advanced oxidation treatment reaction in which bonds between carbon (C) and hydrogen (H) in the perfluorinated compound are broken using vacuum ultraviolet rays and the perfluorinated compound is decomposed, is performed; a second reduction treatment pipe, which communicates with the first oxidation treatment pipe and is equipped with a second vacuum ultraviolet irradiation device and in which an advanced reduction treatment reaction in which bonds between carbon (C) and fluorine (F) in the perfluorinated compound that is not decomposed in the first oxidation treatment pipe are broken using vacuum ultraviolet rays and a reducing agent and the perfluorinated compound is decomposed, is performed; a third oxidation treatment pipe, which communicates with the second reduction treatment pipe and is equipped with a third vacuum ultraviolet irradiation device and in which bonds between carbon (C) and hydrogen (H) in the perfluorinated compound that is not decomposed are broken using vacuum ultraviolet rays and an oxidizer and the perfluorinated compound is decomposed; a first connection pipe which connects between the first oxidation treatment pipe and the second reduction treatment pipe; a reducing agent injection unit configured to inject the reducing agent into the first connection pipe; a second connection pipe which connects between the second reduction treatment pipe and the third oxidation treatment pipe; and an oxidizer injection unit configured to inject the oxidizer into the second connection pipe, wherein the reducing agent includes sulfite, and the oxidizer includes peroxide hydrogen, and in the first oxidation treatment pipe, vacuum ultraviolet rays generated in the first vacuum ultraviolet irradiation device photolyze water to generate OH radicals, and the OH radicals break bonds between carbon (C) and hydrogen (H) in the perfluorinated compound so that the perfluorinated compound is decomposed, and in the second reduction treatment pipe, vacuum ultraviolet rays generated in the second vacuum ultraviolet irradiation device photolyze the sulfite to generate hydration electrons, and the hydration electrons break bonds between carbon (C) and fluorine (F) in the perfluorinated compound that is not decomposed in an advanced oxidation treatment reaction of the first oxidation treatment pipe and bonds between carbon (C) and fluorine (F) in a first decomposition product additionally generated in the advanced oxidation treatment reaction, thereby defluorinating the perfluorinated compound, and in the third oxidation treatment pipe, vacuum ultraviolet rays generated in the third vacuum ultraviolet irradiation device decompose peroxide hydrogen to generate OH radicals, and the OH radicals break bonds between carbon (C) and hydrogen (H) in a second decomposition product in which, in the advanced reduction treatment reaction, fluorine (F) is replaced by hydrogen (H) and which is additionally generated, so that the perfluorinated compound is decomposed.

### Effects of the Invention

A water treatment apparatus for decomposing perfluorinated compound on the basis of vacuum ultraviolet rays according to the present invention, connects a plurality of water treatment pipes each having a vacuum ultraviolet irradiation device in series, so as to sequentially perform oxidation, treatment, reduction treatment, and oxidation treatment while water to be treated sequentially passes through the water treatment pipes, thereby being capable of decomposing, among perfluorinated compounds in the water to be treated, fluorotelomers in which carbon (C) and hydrogen (H) are combined as well as perfluoroalkyls in which carbon (C) and fluorine (F) are combined, and bonds between carbon (C) and hydrogen (H) and bonds between carbon (C) and fluorine (F) can both be decomposed in decomposition products additionally generated during oxidation or reduction treatment reactions, and accordingly, through a series of processes, water treatment efficiency can be improved.

### DESCRIPTION OF THE DRAWINGS

FIG. 1 is a view schematically illustrating a water treatment apparatus for decomposing a perfluorinated compound on the basis of vacuum ultraviolet rays according to an embodiment of the present invention.

FIG. 2 is a view sequentially illustrating a water treatment operation in the water treatment apparatus shown in FIG. 1.

### MODE OF THE INVENTION

Hereinafter, an embodiment of the present invention will be described as below with reference to the accompanying drawings.

The water treatment apparatus for decomposing perfluorinated compound on the basis of vacuum ultraviolet rays according to the embodiment of the present invention is an apparatus for decomposing a perfluorinated compound contained in water to be treated, and performing water treatment on the perfluorinated compound.

The perfluorinated compound includes perfluoroalkyl substances (PFAS) in which carbon (C) of the alkyl group is saturated with fluorine (F), and fluorotelomer substances in which some of carbon (C) of the alkyl group is not replaced by fluorine (F) and remains as hydrogen (H).

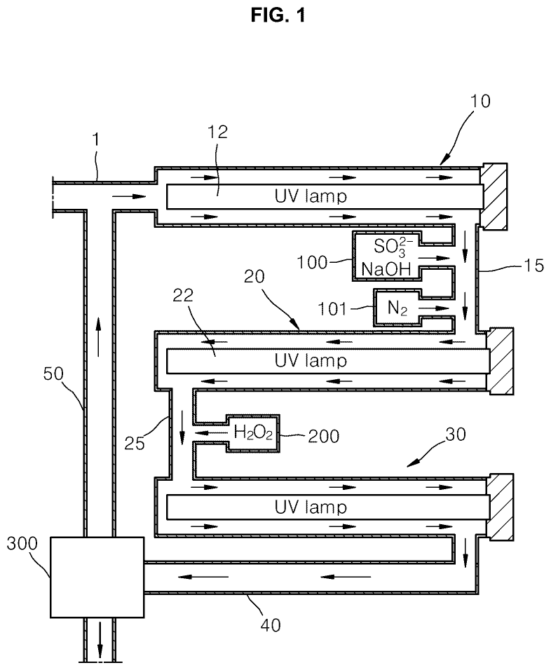

FIG. 1 is a view schematically illustrating a water treatment apparatus for decomposing a perfluorinated compound on the basis of vacuum ultraviolet rays according to an embodiment of the present invention. Referring to FIG. 1, the water treatment apparatus for decomposing a perfluorinated compound on the basis of vacuum ultraviolet rays according to the embodiment of the present invention includes a treatment water inlet pipe 1, a first oxidation treatment pipe 10, a second reduction treatment pipe 20, a third oxidation treatment pipe 30, a first connection pipe 15, a second connection pipe 25, a discharge pipe 40, a return pipe 50, a reducing agent injection unit 100, and an oxidizer injection unit 200.

The treatment water inlet pipe 1 is a pipe into which water to be treated, including the perfluorinated compound, flows.

The first oxidation treatment pipe 10 is a water treatment pipe which is connected in series to the treatment water inlet pipe 1 and in which a first vacuum ultraviolet lamp 12 is provided as a first vacuum ultraviolet irradiation device. It will be described that the first oxidation treatment pipe 10 is formed as a pipe made of a stainless material not to be deformed by ultraviolet rays, but the present invention is not limited thereto, and any material that is not deformed by ultraviolet rays may be applied by changing the material in various ways. In the first oxidation treatment pipe 10, contaminants are photolyzed by vacuum ultraviolet (VUV) generated in the first vacuum ultraviolet lamp 12, and an advanced oxidation treatment reaction is performed to break bonds between carbon (C) and hydrogen (H) in the perfluorinated compound and decompose the perfluorinated compound using OH radicals generated during photolysis.

The first vacuum ultraviolet lamp 12 is arranged lengthwise in the center of the first oxidation treatment pipe 10.

The second reduction treatment pipe 20 is a water treatment pipe, which is connected in series to the first oxidation treatment pipe 10 and into which water to be treated discharged from the first oxidation treatment pipe 10 flows. The second reduction treatment pipe 20 is equipped with the second vacuum ultraviolet ray lamp 22 as a second vacuum ultraviolet irradiation device therein. It will be described that the second reduction treatment pipe 20 is formed as a pipe made of a stainless steel material not to be deformed by ultraviolet rays, but the present invention is not limited thereto, and any material that is not deformed by ultraviolet rays may be applied by changing the material in various ways. In the second reduction treatment pipe 20, the vacuum ultraviolet rays generated from the second vacuum ultraviolet lamp 22 photolyzes a reducing agent, sulfite, which will be described later, to generate hydration electrons. The hydration electrons break bonds between carbon (C) and fluorine (F) in the perfluorinated compound that is not decomposed in the first oxidation treatment pipe 10, thereby decomposing the perfluorinated compound, and break bonds between carbon (C) and fluorine (F) in a first decomposition product additionally generated after decomposition in the advanced oxidation treatment reaction of the first oxidation treatment pipe 10, thereby defluorinating the perfluorinated compound, so that an advanced reduction treatment reaction occurs in the second reduction treatment pipe 20.

The second vacuum ultraviolet lamp 22 is arranged lengthwise in the center of the second oxidation treatment pipe 20.

The third oxidation treatment pipe 30 is a water treatment pipe, which is connected in series to the second reduction treatment pipe 20 and into which water to be treated discharged from the second reduction treatment pipe 20 flows. The third oxidation treatment pipe 30 is equipped with a third vacuum ultraviolet ray lamp 33 as a third vacuum ultraviolet irradiation device therein. It will be described that the third oxidation treatment pipe 30 is formed as a pipe made of a stainless steel material not to be deformed by ultraviolet rays, but the present invention is not limited thereto, and any material that is not deformed by ultraviolet rays may be applied by changing the material in various ways. In the third oxidation treatment pipe 30, the vacuum ultraviolet rays generated from the second vacuum ultraviolet lamp 32 decomposes an oxidizer, hydrogen peroxide, which will be described later, to generate OH radicals. The OH radicals generated in the third oxidation treatment pipe 30 break bonds between carbon (C) and hydrogen (H) in the perfluorinated compound that is not decomposed in the second reduction treatment pipe 20 and bonds between carbon (C) and hydrogen (H) in a second decomposition product in which fluorine (F) is replaced by hydrogen (H) in the advanced reduction treatment reaction and which is additionally generated, thereby defluorinating the perfluorinated compound, so that an advanced reduction treatment reaction occurs in the third oxidation treatment pipe 30.

The third vacuum ultraviolet lamp 32 is arranged lengthwise in the center of the third oxidation treatment pipe 30.

Meanwhile, the first oxidation treatment pipe 10 and the second reduction treatment pipe 20 are connected to each other by the first connection pipe 15. The first connection pipe 15 is a flow path that connects in series between a discharge port of the first oxidation treatment pipe 10 and an inlet of the second reduction treatment pipe 20. In the first connection pipe 15, a reducing agent injection unit 100 for injecting the reducing agent is provided.

It will be described that the reducing agent is sulfite. Sulfite is an inorganic salt of sulfurous acid with SO₃²⁻. In the present embodiment, it will be described that sodium sulfite (Na₂SO₃) is used as the reducing agent. However, the present invention is not limited thereto, and in addition to sulfite ions, it is also possible to add iodine ions, indole, and dithionite.

In addition, a pH regulator is injected into the first connection pipe 15 to regulate pH of the water to be treated, from the first oxidation treatment pipe 10. It will be described that the pH regulator uses sodium hydroxide (NaOH). In the present embodiment, it will be described that the pH regulator is injected through the reducing agent injection unit 100. However, the present invention is not limited thereto, and the pH regulator may also be injected through an injection portion provided separately from the reducing agent injection unit 100 or may be directly injected into the second reduction treatment pipe 20. In addition, the first connection pipe 15 is equipped with a nitrogen injection unit 101.

The nitrogen injection unit 101 injects nitrogen (N₂) for removing dissolved oxygen in water to be treated from the first oxidation treatment pipe 10. In the present embodiment, it will be descried that nitrogen (N₂) is injected through the nitrogen injection unit 101 provided separately from the reducing agent injection unit 100, but the present invention is not limited thereto, and nitrogen (N₂) may also be injected together through the reducing agent injection unit 100 and may also be directly injected into the second reduction treatment pipe 20. Meanwhile, the second reduction treatment pipe 20 and the third oxidation treatment pipe 30 are connected to each other by the second connection pipe 25. The second connection pipe 25 is a flow path that connects in series between a discharge port of the second reduction treatment pipe 20 and an inlet of the third oxidation treatment pipe 30. An oxidizer injection unit 20 for injecting the oxidizer is provided in the second connection pipe 25. It will be described that the oxidizer is hydrogen peroxide (H₂O₂). However, the present invention is not limited thereto, and in addition to hydrogen peroxide, hypochlorous acid (HOCl), persulfate or the like may also be added.

Meanwhile, the discharge pipe 40 is connected to a discharge port of the third oxidation treatment pipe 30. The discharge pipe 40 is a flow path for discharging water to be treated from the third oxidation treatment pipe 30 to the outside. The discharge pipe 40 is equipped with a water quality measuring device 300 for measuring the water quality of water to be treated, before being discharged to the outside. The water quality measuring device 300 measures fluorine ions, hydrogen peroxide concentration, and sulfite ion concentration, in water to be treated, respectively.

The return pipe 50 is a flow path branched from a point where the water quality measuring device 300 is installed in the discharge pipe or from a point downstream from the water quality measuring device 300 and connected to the treatment water inflow pipe 1. The return pipe 50 is a flow path on which, when the water quality measured by the water quality measuring device 300 exceeds a preset reference, some of water to be treated, discharged to the discharge pipe is returned to the treatment water inlet pipe 1. A return pipe valve (not shown) for opening/closing the return pipe 50 is provided in the return pipe 50 according to the water quality measured by the water quality measuring device 300.

The water treatment apparatus further includes a controller (not shown) for controlling the operation of the return pipe valve (not shown) according to the water quality measured by the water quality measuring device 300. The controller (not shown) may also control the amount injected by the reducing agent injection unit 100, the nitrogen injection unit 101, and the oxidizer injection unit 200, respectively, according to the water quality measured by the water quality measuring device 300.

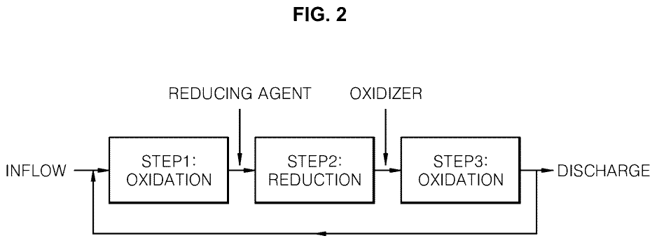

The action of the water treatment apparatus for decomposing a perfluorinated compound on the basis of vacuum ultraviolet rays will be described as below. FIG. 2 is a view sequentially illustrating a water treatment operation in the water treatment apparatus shown in FIG. 1.

The water treatment apparatus for decomposing a perfluorinated compound on the basis of vacuum ultraviolet rays sequentially performs a first oxidation treatment operation (STEP 1), a second reduction treatment operation (STEP 2), and a third oxidation treatment operation (STEP 3).

Referring to FIGS. 1 and 2, water to be treated, flowing into the treatment water inflow pipe 1 passes through the first oxidation treatment pipe 10. The first oxidation treatment pipe 10 performs the first oxidation treatment operation (STEP 1).

The first oxidation treatment operation (STEP 1) is an operation in which, in the first oxidation treatment pipe 10, vacuum ultraviolet rays generated in the first vacuum ultraviolet lamp 12 photolyzes water so that OH radicals are generated and an advanced oxidation treatment reaction in which the OH radicals break bonds between carbon (C) and hydrogen (H) in the perfluorinated compound contained in water to be treated and the perfluorinated compound is decomposed. Chemical formula 1 and Chemical formula 2 are reaction formulae that represent a vacuum ultraviolet reaction.

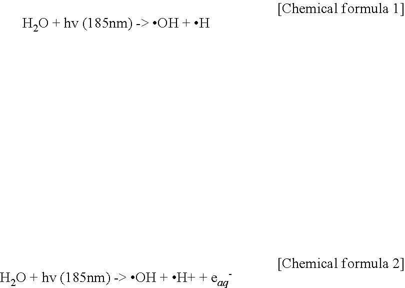

Table 1 schematically shows a material to be decomposed in the water treatment operation according to the perfluorinated compound and a decomposition product.

TABLE 1

| | | STEP 2 | STEP 3 |
|---|---|---|---|
| | STEP 1 | (second oxidation | (third oxidation |
| Perfluorinated compound | (first oxidation treatment pipe) | treatment pipe) | treatment pipe) |
| Fluorotelomer | - Fluorotelomer(C-H) | - First decomposition | - Second |
| (C-H bond structure) | decomposition O | product (C-F) | decomposition |
| | - First decomposition product | decomposition O | product (C-H) |
| | (C-F) generation | - Second | decomposition |
| | | decomposition product | O |
| | | (C-F) generation | |
| 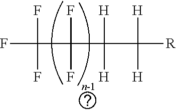 | 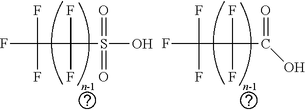 | 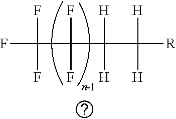 | |
| Perfluoroalkyls | - Perfluoroalkyls (C-F) | - Perfluoroalkyls (C-F) | - Second |
| (C-F bond structure) | decomposition X | decomposition O | decomposition |
| | | - Second | product (C-H) |
| | | decomposition product | decomposition |
| | | (C-F) generation | O |
| 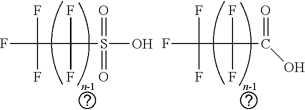 | 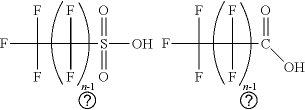 | 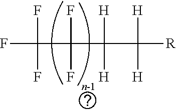 | |

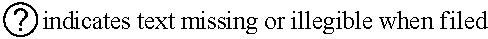

Referring to Table 1, the perfluorinated compound contained in water to be treated, includes perfluoroalkyl substances (PFAS) in which all carbons (C) of the alkyl group are saturated with fluorine (F), depending on the structure, and fluorotelomers in which some of carbons (C) is not replaced by fluorine (F) but remain as hydrogen (H).

In the advanced oxidation treatment reaction that occurs in the first oxidation treatment operation (STEP 1), only bonds between carbon (C) and hydrogen (H) of fluorotelomers may be decomposed, and perfluoroalkyl substances in which carbon (C) is saturated with fluorine (F), are not decomposed.

In the first oxidation treatment operation (STEP 1), a first decomposition product is generated. The first decomposition product is substances in which carbon (C) and fluorine (F) are combined and thus are perfluoroalkyl substances in which, in the advanced oxidation treatment reaction, bonds between carbon (C) and hydrogen (H) of fluorotelomer are decomposed and bonds between carbon (C) and fluorine (F) remain and which are generated. That is, the fluorotelomer is substances in which some of carbon (C) of the alkyl group is not replaced by fluorine (F) and remains as hydrogen (H) and bonds between carbon (C) and hydrogen (H) and bonds between carbon (C) and fluorine (F) exist and thus, in the first oxidation treatment operation (STEP 1), perfluoroalkyl substances in which, by an oxidation treatment reaction, bonds between carbon (C) and hydrogen (H) are decomposed and bonds between carbon (C) and fluorine (F) remain, are generated. Thus, the perfluorinated compound remains in water to be treated, which is oxidized while passing through the first oxidation treatment pipe 10, and the perfluoroalkyl substances in carbon (C) and fluorine (F) that are not decomposed the oxidation treatment reaction of the first oxidation treatment operation (STEP 1) are combined, and a first decomposition product in which carbon (C) and fluorine (F) additionally generated during an oxidation treatment process are combined, are contained in water to be treated, which is oxidized while passing through the first oxidation treatment pipe 10.

Meanwhile, water to be treated, which is oxidized in the first oxidation treatment pipe 10, flows into the second reduction treatment pipe 20. The reducing agent, the pH regulator, and nitrogen (N₂) are injected between the first oxidation treatment pipe 10 and the second oxidation treatment pipe 20. In the present embodiment, it will be described that the reducing agent uses sodium sulfite (Na₂SO₃) and the pH regulator uses sodium hydroxide (NaOH). In the second reduction treatment pipe 20, the second reduction treatment operation (STEP 2) is performed. In the second reduction treatment pipe 20, pH of water to be treated is regulated by alkalinity by the pH regulator, and dissolved oxygen is removed by nitrogen.

Referring to Chemical formula 3, the second reduction treatment operation (STEP 2) is an operation in which vacuum ultraviolet rays generated in the second vacuum ultraviolet lamp 22 in the second reduction treatment pipe 20 photolyze sulfurous acid (SO₃²⁻) so that hydration electrons e_{aq}⁻ are generated and an advanced reduction treatment reaction in which contaminants are decomposed by the hydration electrons is performed. The hydration electrons generated in the second reduction treatment pipe 20 break bonds between carbon (C) and fluorine (F) in the perfluorinated compound contained in water to be treated, thereby defluorinating the perfluorinated compound.

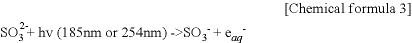

Referring to Table 1, in the advanced reduction treatment reaction that occurs in the second reduction treatment operation (STEP 2), bonds between carbon (C) and fluorine (F) may be decomposed, but bonds between carbon (C) and hydrogen (H) are not decomposed. That is, in the advanced reduction treatment reaction, decomposition of the perfluoroalkyl substances in which carbon (C) and fluorine (F) are combined, is possible, but fluorotelomer substances in which carbon (C) and hydrogen (H) are combined, are not decomposed.

In the advanced reduction treatment reaction, bonds between carbon (C) and fluorine (F) in the first decomposition product generated in the first oxidation treatment operation (STEP 1) are broken, and bonds between carbon (C) and fluorine (F) of perfluoroalkyls that are not decomposed in the first oxidation treatment operation (STEP 1) and remains, are broken, thereby defluorinating the perfluoroalkyls. In this case, in the second reduction treatment operation (STEP 2), a second decomposition product is generated. The second decomposition product is substances in which carbon (C) and fluorine (F) are combined. The second decomposition product is fluorotelomer substances in which, when, in the advanced reduction treatment reaction, bonds between carbon (C) and fluorine (F) are decomposed, some of fluorine (F) is replaced by hydrogen (H) and carbon (C) and hydrogen (H) are combined. Since the fluorotelomer substances are not decomposed in a reduction treatment reaction, a third oxidation treatment operation (STEP 3) to be described later is required. That is, in the second reduction treatment operation (STEP 2), bonds between carbon (C) and fluorine (F) are broken, and the fluorotelomer substances may be defluorinated, but the second decomposition product having the shape of fluorotelomer in which carbon (C) and hydrogen (H) are combined, is additionally generated. Thus, the perfluorinated compound remains in water to be treated, which is reduction treated while passing through the second reduction treatment pipe 20, and a second decomposition product in which carbon (C) and hydrogen (H) additionally generated in the reduction treatment reaction of the second reduction treatment operation (STEP 2) are combined, is contained in water to be treated, which is reduction treated while passing through the second oxidation treatment pipe 20.

Meanwhile, water to be treated, which is reduction treated in the second reduction treatment pipe 20, flows into the third oxidation treatment pipe 30. The oxidizer is injected between the second reduction treatment pipe 20 and the third reduction treatment pipe 30. In the present embodiment, it will be described that the oxidizer is hydrogen peroxide (H₂O₂). In the third oxidation treatment pipe 30, the third oxidation treatment operation (STEP 3) is performed.

The third oxidation treatment operation (STEP 3) is an operation in which vacuum ultraviolet rays generated in the third vacuum ultraviolet lamp 32 in the third oxidation treatment pipe 30 photolyze the hydrogen peroxide (H₂O₂) to generate OH radicals and remove remaining sulfurous acid (SO₃²⁻) and an advanced oxidation treatment reaction in which bonds between carbon (C) and hydrogen (H) in the perfluorinated compound contained in water to be treated, are broken and the perfluorinated compound is decomposed, is performed.

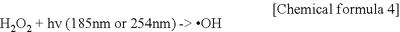

Referring to Table 1, in the advanced oxidation treatment reaction that occurs in the third oxidation treatment operation (STEP 3), bonds between carbon (C) and hydrogen (H) may be decomposed. That is, in the third oxidation treatment pipe 30, fluorotelomer substances, which are a second decomposition product generated in the second reduction treatment pipe 20, may be decomposed.

As described above, in the embodiment of the present invention, while water to be treated sequentially passes through the first oxidation treatment pipe 10, the second reduction treatment pipe 20 and the third oxidation treatment pipe 30, oxidation treatment, reduction treatment, and oxidation treatment are sequentially performed so that, in addition to bonds between carbon (C) and hydrogen (H), bonds between carbon (C) and fluorine (F) may also be decomposed. That is, in addition to perfluoroalkyls in which carbon (C) and fluorine (F) among the perfluorinated compound are combined, decomposition of fluorotelomer in which carbon (C) and hydrogen (H) are combined, is possible, and bonds between carbon (C) and hydrogen (H) and bonds between carbon (C) and fluorine (F) in the decomposition product additionally generated during an oxidation or reduction treatment reaction may also be decomposed.

Meanwhile, water to be treated, from the third oxidation treatment pipe 30 flows into the discharge pipe 40. The water quality measuring device 300 measures the quality of water to be treated, flowing into the discharge pipe 40. The water quality measuring device 300 measures fluorine ion concentration, hydrogen peroxide concentration, and sulfite concentration of water to be treated, respectively. When at least one among the fluorine ion concentration, the hydrogen peroxide concentration and the sulfite concentration measured by the water quality measuring device 300 exceeds a preset reference concentration for each of the fluorine ion concentration, the hydrogen peroxide concentration and the sulfite concentration, water to be treated is returned to the treatment water inflow pipe 1 through the return pipe 50 again. Thus, while water to be treated, in which at least one among the fluorine ion concentration, the hydrogen peroxide concentration and the sulfite concentration exceeds the reference concentration, sequentially passes through the first oxidation treatment pipe 10, the second reduction treatment pipe 20, and the third oxidation treatment pipe 30, oxidation treatment and reduction treatment may be additionally performed.

When at least one among the fluorine ion concentration, the hydrogen peroxide concentration and the sulfite concentration is less than or equal to the preset reference concentration, water to be treated may be discharged to the outside.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

When using the present invention, a water treatment apparatus for decomposing a perfluorinated compound on the basis of vacuum ultraviolet rays in which decomposition and defluorination of the perfluorinated compound can be achieved, can be manufactured.

1. A water treatment apparatus for decomposing a perfluorinated compound on the basis of vacuum ultraviolet rays, the water treatment apparatus comprising:
a treatment water inflow pipe into which water to be treated, including perfluoroalkyl substances (PFAS) in which carbon (C) of the alkyl group is saturated with fluorine (F), and fluorotelomer substances in which some of carbon (C) of the alkyl group is not replaced by fluorine (F) and remains as hydrogen (H), flows;
a first oxidation treatment pipe, which communicates with the treatment water inflow pipe and is equipped with a first vacuum ultraviolet irradiation device and in which an advanced oxidation treatment reaction in which bonds between carbon (C) and hydrogen (H) in the perfluorinated compound are broken using vacuum ultraviolet rays and the perfluorinated compound is decomposed, is performed;
a second reduction treatment pipe, which communicates with the first oxidation treatment pipe and is equipped with a second vacuum ultraviolet irradiation device and in which an advanced reduction treatment reaction in which bonds between carbon (C) and fluorine (F) in the perfluorinated compound that is not decomposed in the first oxidation treatment pipe are broken using vacuum ultraviolet rays and a reducing agent and the perfluorinated compound is decomposed, is performed; and
a third oxidation treatment pipe, which communicates with the second reduction treatment pipe and is equipped with a third vacuum ultraviolet irradiation device and in which bonds between carbon (C) and hydrogen (H) in the perfluorinated compound that is not decomposed are broken using vacuum ultraviolet rays and an oxidizer and the perfluorinated compound is decomposed.

2. The water treatment apparatus of claim 1, wherein, in the first oxidation treatment pipe, vacuum ultraviolet rays generated in the first vacuum ultraviolet irradiation device photolyze water to generate OH radicals, and the OH radicals break bonds between carbon (C) and hydrogen (H) in the perfluorinated compound so that the perfluorinated compound is decomposed.

3. The water treatment apparatus of claim 1, wherein the reducing agent comprises sulfite, and in the second reduction treatment pipe, vacuum ultraviolet rays generated in the second vacuum ultraviolet irradiation device photolyze the sulfite to generate hydration electrons, and the hydration electrons break bonds between carbon (C) and fluorine (F) in the perfluorinated compound that is not decomposed in an advanced oxidation treatment reaction of the first oxidation treatment pipe and bonds between carbon (C) and fluorine (F) in a first decomposition product additionally generated in the advanced oxidation treatment reaction, thereby defluorinating the perfluorinated compound.

4. The water treatment apparatus of claim 1, wherein the oxidizer comprises peroxide hydrogen, and in the third oxidation treatment pipe, vacuum ultraviolet rays generated in the third vacuum ultraviolet irradiation device decompose peroxide hydrogen to generate OH radicals, and the OH radicals break bonds between carbon (C) and hydrogen (H) in a second decomposition product in which, in an advanced reduction treatment reaction of the second reduction treatment pipe, fluorine (F) is replaced by hydrogen (H) and which is additionally generated, so that the perfluorinated compound is decomposed.

5. The water treatment apparatus of claim 1, further comprising a first connection pipe that connects between the first oxidation treatment pipe and the second reduction treatment pipe, and a reducing agent injection unit for injecting the reducing agent into the first connection pipe.

6. The water treatment apparatus of claim 5, wherein a pH regulator for regulating pH of water to be treated, and nitrogen for removing dissolved oxygen in water to be treated, are injected into the first connection pipe.

7. The water treatment apparatus of claim 1, further comprising a second connection pipe that connects between the second reduction treatment pipe and the third oxidation treatment pipe, and an oxidizer injection unit for injecting the oxidizer into the second connection pipe.

8. The water treatment apparatus of claim 1, further comprising a discharge pipe connected to a discharge port of the third oxidation treatment pipe and configured to discharge water to be treated, from the third oxidation treatment pipe to the outside, and a water quality measuring device provided in the discharge pipe and configured to measure water quality of water to be treated.

9. The water treatment apparatus of claim 8, further comprising a return pipe, which is branched from the discharge pipe and connected to the treatment water inflow pipe and in which, when water quality measured by the water quality measuring device exceeds a preset reference, some of water to be treated discharged through the discharge pipe is returned to the treatment water inflow pipe, and a return pipe valve which opens/closes the return pipe.

10. The water treatment apparatus of claim 9, wherein the reducing agent comprises sulfite, and the oxidizer comprises peroxide hydrogen, and the water quality measuring device measures fluorine ions, hydrogen peroxide concentration, and sulfite ion concentration, in water to be treated.

11. The water treatment apparatus of claim 1, wherein the first vacuum ultraviolet irradiation device comprises a first vacuum ultraviolet lamp, and the second vacuum ultraviolet irradiation device comprises a second vacuum ultraviolet lamp, and the third vacuum ultraviolet irradiation device comprises a third vacuum ultraviolet lamp.

12. The water treatment apparatus of claim 1, wherein the second reduction treatment pipe is connected in series to the first oxidation treatment pipe, and the third reduction treatment pipe is connected in series to the second reduction treatment pipe.

13. A water treatment apparatus for decomposing a perfluorinated compound on the basis of vacuum ultraviolet rays, the water treatment apparatus comprising:
a treatment water inflow pipe into which water to be treated, including perfluoroalkyl substances (PFAS) in which carbon (C) of the alkyl group is saturated with fluorine (F), and fluorotelomer substances in which some of carbon (C) of the alkyl group is not replaced by fluorine (F) and remains as hydrogen (H), flows;
a first oxidation treatment pipe, which communicates with the treatment water inflow pipe and is equipped with a first vacuum ultraviolet irradiation device and in which an advanced oxidation treatment reaction in which bonds between carbon (C) and hydrogen (H) in the perfluorinated compound are broken using vacuum ultraviolet rays and the perfluorinated compound is decomposed, is performed;
a second reduction treatment pipe, which communicates with the first oxidation treatment pipe and is equipped with a second vacuum ultraviolet irradiation device and in which an advanced reduction treatment reaction in which bonds between carbon (C) and fluorine (F) in the perfluorinated compound that is not decomposed in the first oxidation treatment pipe are broken using vacuum ultraviolet rays and a reducing agent and the perfluorinated compound is decomposed, is performed;
a third oxidation treatment pipe, which communicates with the second reduction treatment pipe and is equipped with a third vacuum ultraviolet irradiation device and in which bonds between carbon (C) and hydrogen (H) in the perfluorinated compound that is not decomposed are broken using vacuum ultraviolet rays and an oxidizer and the perfluorinated compound is decomposed;
a first connection pipe which connects between the first oxidation treatment pipe and the second reduction treatment pipe;
a reducing agent injection unit configured to inject the reducing agent into the first connection pipe;
a second connection pipe which connects between the second reduction treatment pipe and the third oxidation treatment pipe; and
an oxidizer injection unit configured to inject the oxidizer into the second connection pipe,
wherein the reducing agent comprises sulfite, and the oxidizer comprises peroxide hydrogen, and in the first oxidation treatment pipe, vacuum ultraviolet rays generated in the first vacuum ultraviolet irradiation device photolyze water to generate OH radicals, and the OH radicals break bonds between carbon (C) and hydrogen (H) in the perfluorinated compound so that the perfluorinated compound is decomposed, and in the second reduction treatment pipe, vacuum ultraviolet rays generated in the second vacuum ultraviolet irradiation device photolyze the sulfite to generate hydration electrons, and the hydration electrons break bonds between carbon (C) and fluorine (F) in the perfluorinated compound that is not decomposed in an advanced oxidation treatment reaction of the first oxidation treatment pipe and bonds between carbon (C) and fluorine (F) in a first decomposition product additionally generated in the advanced oxidation treatment reaction, thereby defluorinating the perfluorinated compound, and in the third oxidation treatment pipe, vacuum ultraviolet rays generated in the third vacuum ultraviolet irradiation device decompose peroxide hydrogen to generate OH radicals, and the OH radicals break bonds between carbon (C) and hydrogen (H) in a second decomposition product in which, in the advanced reduction treatment reaction, fluorine (F) is replaced by hydrogen (H) and which is additionally generated, so that the perfluorinated compound is decomposed.
